(19) United States
(12) Patent Application Publication
(10) Pub. No.: US 2018/0187556 A1
(43) Pub. Date: Jul. 5, 2018

(54) TURBOENGINE BLADING MEMBER

(71) Applicant: ANSALDO ENERGIA IP UK LIMITED, London (GB)

(72) Inventors: Herbert Brandl, Waldshut-Tiengen (DE); Jiwen Tao, Warwickshire (GB); Philip Corser, London (GB); Arthur Mateusz Faflik-Brooks, Lodz (PL); Andrew Wilson, Northampton (GB)

(73) Assignee: ANSALDO ENERGIA IP UK LIMITED, London (GB)

(21) Appl. No.: 15/855,490

(22) Filed: Dec. 27, 2017

(30) Foreign Application Priority Data
Dec. 30, 2016 (EP) 16207567.5

(51) Int. Cl. F01D 5/18

(52) U.S. Cl. CPC F01D 5/187; F05D 2220/32; F05D 2260/20; F05D 2240/55; F05D 2240/81

(57) ABSTRACT

A turboengine blading member having a platform and an airfoil. The airfoil includes a pressure side, a suction side, a leading edge and a trailing edge. An upstream region of the airfoil extends from the leading edge in a direction towards the trailing edge and a downstream region of the airfoil extends from the trailing edge in a direction towards the leading edge. The airfoil is connected to the platform in the upstream region, and is disconnected from the platform in the downstream region, such that the downstream region cantilevers from the upstream region, whereby a gap is formed between a cross sectional face of the airfoil in the downstream region and an opposed surface of the platform facing the cross sectional face. A sealing member is provided inside airfoil and platform pockets and bridges the gap.

### PRIORITY CLAIM

This application claims priority from European Patent Application No. 16207567.5 filed on Dec. 30, 2016, the disclosure of which is incorporated by reference.

### TECHNICAL FIELD

The present disclosure relates to a turboengine blading member according to claim 1.

### BACKGROUND OF THE DISCLOSURE

25 Turboengine blading members usually comprise at least one platform and at least one airfoil. The airfoil comprises a leading edge, a trailing edge, and extends in a spanwise direction from the at least one platform. The airfoil is connected to a platform at at least one spanwise end of the airfoil. It may be the case that the airfoil is connected to a platform at each spanwise end. It may also be the case 30 that a blading member comprises more than one airfoil. Blading members may be integrally formed, or may be assembled. For instance, the blading member may be assembled from at least one airfoil member and at least one platform member. In said case, the airfoil member may comprise a post or other male connection feature attached to the airfoil at a spanwise end of the airfoil, and which is received within a mating female connection feature of the platform member, and is interlocked in there, as for instance known from U.S. Pat. No. 5,797,725 and US 2009/0196761.

It is common in assembled blading members of the manner mentioned above that the post or male fixation feature extends in a spanwise direction from an upstream region of the airfoil, and exhibits a cross section which at least essentially is congruent with a cross section of the airfoil in an upstream region. However, quite commonly the cross section of the male fixation feature does not extend over a downstream region of the airfoil. Accordingly, the airfoil is connected to the platform in an upstream region, while it is disconnected from the platform in the downstream region, and a gap is formed between a cross sectional face of the airfoil in the downstream region and an opposed surface of the platform. An upstream region is in this respect to be understood as any region of the airfoil extending from the leading edge and some distance downstream, while a downstream region extends from the trailing edge and some distance upstream. Upstream and downstream, respectively, relate to a nominal flow direction of the airfoil, which is directed from the leading edge to the trailing edge. The downstream region may be defined as a section of the airfoil which extends from the trailing edge to a downstream end of the male fixation feature. The upstream region may then be defined as a section reaching from the leading edge to the downstream end of the male fixation feature. The upstream region may also be referred to as a leading edge region. The downstream region may also be referred to as a trailing edge region.

Providing the airfoil in the downstream region disconnected from the platform bears certain advantages. On the one hand, due to the fact that a sharp corner, or a radius as small as practically possible, respectively, is commonly provided at the leading edge it may be challenging to provide the fixation feature and the related interlocking elements appropriately at the trailing edge and at the same time provide for mechanical integrity at said sharp edge of the male fixation feature. It may moreover prove challenging and expensive to provide the female fixation feature with a corresponding sharp edge or small radius. In another aspect, which relates to assembled blading members as well as to integrally formed blading members, the gap between the cross sectional face of the airfoil and the opposed surface of the platform allows for some displacement between the downstream region of the airfoil and the platform. It is understood that due to cooling on the one hand and heat intake from a hot working fluid flow the airfoil may exhibit significantly higher temperature than the platform during turboengine operation, which causes different thermally induced deformations of the platform and the airfoil, and accordingly stresses are induced at the interface between the airfoil and the platform. Due to the low material strength at the trailing edge, said stresses would prove most critical in the downstream region of the airfoil. In that the airfoil is disconnected from the platform in the downstream region, the downstream region of the airfoil may displace relatively to the platform. Thus, the different thermal expansion of the platform and the airfoil do not induce stresses at an interface between the platform and the airfoil in the downstream region of the airfoil. However, a gap is thus formed between a cross sectional face of the airfoil in the downstream region and an opposed surface of the platform. Leakage flows through the gap from the pressure side of the airfoil to the suction side of the airfoil cause performance losses and are moreover suspect to increase thermal loading of the airfoil in the downstream or trailing edge region.

### OUTLINE OF THE SUBJECT MATTER OF THE PRESENT DISCLOSURE

It is an object of the present disclosure to propose a turboengine blading member of the kind initially mentioned. In an aspect, a blading member shall be proposed in which the trailing edge region or downstream region of an airfoil is disconnected from the platform such as to avoid stresses at an interface between the airfoil and the platform in the downstream region of the airfoil, while leakage flow through a gap formed between the cross sectional face of the airfoil in the downstream region and an opposed surface of the platform are inhibited or at least significantly reduced. In a further aspect, a sealing arrangement for said gap shall be provided which does not inhibit relative displacement between the downstream region of the airfoil and the platform. In still a further aspect, the sealing arrangement shall be able to withstand elevated temperatures in the hot gas path of a turboengine. The sealing arrangement shall, in more specific aspects, be easy and inexpensive to manufacture.

This is achieved by the subject matter described in claim 1.

Accordingly, disclosed is a turboengine blading member comprising at least one platform and at least one airfoil. The airfoil, in a manner familiar to the skilled person, comprises a suction side, a pressure side, a leading edge and a trailing edge. An upstream region of the airfoil extends in a streamwise direction from the leading edge in a direction towards the trailing edge and a downstream region of the airfoil extends from the trailing edge in a direction towards the leading edge. The airfoil is connected to the platform in the upstream region and is disconnected from the platform in the downstream region, such that the downstream region cantilevers from the upstream region, and whereby a gap is formed between a cross sectional face of the airfoil in the downstream region and an opposed surface of the platform facing said cross sectional face. It may be said, in a specific aspect, that the downstream region of the airfoil is a cantilevering region of the airfoil, which is floatingly provided neighboring the platform. The upstream region may be defined as the region of the airfoil in which it extends to the platform and is connected to the platform, while the downstream region extends from the trailing edge of the airfoil to the upstream region. An airfoil pocket is provided in the downstream region of the airfoil and opens out onto the cross sectional face of the airfoil. A platform pocket is provided in the platform and opens out onto the surface of the platform opposed the airfoil pocket. The airfoil pocket and the platform pocket are arranged with mutually facing openings. A sealing member is provided inside the pockets and extends into the airfoil pocket as well as into the platform pocket and thereby bridges the gap. The sealing member exhibits a length which extends in a direction from the upstream region of the airfoil towards the trailing edge and a width which extends in a direction from one pocket to the other pocket. The sealing member is thus provided across the gap and inhibits a fluid flow through the gap from the pressure side of the airfoil to the suction side of the airfoil, while not inhibiting the relative displacement between the downstream region of the airfoil and the platform.

Further effects and advantages of the disclosed subject matter, whether explicitly mentioned or not, will become apparent in view of the disclosure provided below.

It is noted that within the framework of the present disclosure the use of the indefinite article “a” or “an” does in no way stipulate a singularity nor does it exclude the presence of a multitude of the named member or feature. It is thus to be read in the sense of “at least one” or “one or a multitude of”.

The sealing member may in particular embodiments be floatingly or loosely, and more in particular with play, and more in particular with play at least in a direction generally oriented between the pressure side and the suction side, provided in the airfoil pocket and the platform pocket. That is, the sealing member is neither fixed to the airfoil nor the platform. The sealing member, exhibiting a length and a width across the gap, will adjust itself dependent on the pressure differential between the pressure side and the suction side, and will, by virtue of the pressure differential, be pressed to the pocket walls to achieve a sealing effect. The sealing effect is thus actuated dependent upon the pressure load due to the pressure differential between the pressure side and the suction side of the airfoil through rigid motion of the sealing member. In that the dimensions of the airfoil pocket and the platform pocket and of the sealing member are provided such that the sealing member is received within the platform pocket and the airfoil pocket with play, the leakage path is sealed at every tolerance condition between the relative position of the platform and the airfoil trailing edge or downstream region, respectively. To that extent, a thickness of the sealing member extends in a direction between the pressure side and the suction side of the airfoil. Said thickness may in a section of the sealing member which is received inside the platform pocket and/or in a section which is received inside the airfoil pocket be smaller than the width of the respective pocket.

In certain exemplary embodiments of the turboengine blading member, each of the airfoil pocket and the platform pocket exhibits a length extending in a direction from the upstream region of the airfoil towards the trailing edge and a width extending in a direction from the pressure side towards the suction side of the airfoil, wherein the length of the pocket is larger than the width of the pocket.

In certain embodiments of the turboengine blading member as herein described, each of the airfoil pocket and the platform pocket exhibits a width extending in a direction from the pressure side of the airfoil to the suction side of the airfoil, and a depth, wherein the depth of each of the airfoil pocket and platform pocket is larger than the width of the respective pocket.

In certain embodiments, each of the airfoil pocket and the platform pocket exhibits a length extending in a direction from the upstream region of the airfoil towards the trailing edge, and a depth, wherein the depth of each of the airfoil pocket and platform pocket is smaller than the length of the respective pocket.

Said geometric parameters of the pockets provide a framework for the geometry of the sealing member which may be received. For instance, the width of the sealing member may be smaller than the sum of the depths of the airfoil pocket and the platform pocket plus a minimum expected width of the gap. If the width of each of the pockets is smaller than the width of the sealing member, the sealing member may accordingly be safely received within the pockets, and the risk of the sealing member canting or tilting inside the pockets or even a loss of sealing member may be avoided.

In certain embodiments of the blading member as herein disclosed the sealing member has a first thickness received inside the airfoil pocket and a second thickness received within the platform pocket, wherein each of the first and second thickness is smaller than the width of the respective pocket in which it is received. This provides for the play of the sealing member inside the pockets in a direction between the pressure side and the suction side. Due to said play, the sealing member is free to displace in the direction of the pressure differential between the pressure side and the suction side and thus to adapt to the pressure differential, and moreover to compensate for relative displacement between the platform and the cantilevering downstream region of the airfoil along a direction between the pressure side of the airfoil and suction side of the airfoil. A superior self-supporting capability of the sealing arrangement is thus provided.

The skilled person will readily appreciate that the airfoil pocket can not practically extend right to the trailing edge, due to the fact that the cross section of the airfoil adjacent the trailing edge is very narrow, and thus simply not providing space to arrange the airfoil pocket. Thus, a downstream end of the airfoil pocket is provided at a certain distance upstream of the trailing edge, and no airfoil pocket is provided adjacent the trailing edge. In order to effect the sealing effect along the entire extent of the airfoil downstream region right to the trailing edge, the blading member is provided such that the airfoil pocket extends from an upstream end of the airfoil pocket to a downstream end of the airfoil pocket, wherein the downstream end of the airfoil pocket is located upstream the trailing edge. The sealing member comprises a first section which is received inside the airfoil pocket and a second section which is located outside the airfoil pocket. The second section extends further downstream than the downstream end of the airfoil pocket.

In particular, the second section of the sealing member extends right to the trailing edge. In specific embodiments, the length of the first section of the sealing member may equal the length of the airfoil pocket. Moreover, the airfoil may extend in a downstream direction right to a downstream end of the platform, or may even be provided with an overhang at the downstream end of the platform. The sealing member may be shaped such that a section of the sealing member which is received inside the platform pocket exhibits a length which equals the length of the platform pocket. A section of the sealing member which is arranged outside the platform pocket and outside the airfoil pocket, and is provided within the gap, may thus extend further downstream than the airfoil pocket or further downstream than the platform pocket, and in particular further downstream than both the airfoil pocket and the platform pocket.

The airfoil may be a cooled airfoil, comprising at least one duct for a coolant inside the airfoil. A fluid channel may be provided within in the airfoil and in fluid communication with an interior of the airfoil, or the at least one cooling duct provided therein, respectively, and in fluid communication with the gap, such as to enable a fluid flow from the interior of the airfoil to the gap. Thus, a coolant may be provided within the gap and serve to reduce the thermal loading of the sealing member. The fluid channel may at its outlet opening to the gap be inclined such that a fluid flow discharged from the fluid channel is directed with a velocity component directed towards the pressure side of the airfoil. This may serve to add an additional aerodynamic sealing effect.

In another instance, the turboengine blading member may be intended to be implemented in a turboengine such that a coolant is provided to a side of the platform which is opposed to the hot fluid exposed side on which the airfoil is arranged. Accordingly, the platform comprises a hot fluid side on which the airfoil is arranged and an opposed cold fluid side. A fluid channel may be provided which extends from the cold fluid side to the gap such as to provide a fluid communication between the cold fluid side and the gap. Thus, a coolant may be provided within the gap and serve to reduce the thermal loading of the sealing member. The fluid channel may at its outlet opening to the gap be inclined such that a fluid flow discharged from the through channel is directed with a velocity component directed towards the pressure side of the airfoil. This may serve to add an additional aerodynamic sealing effect.

In still another instance, aerodynamic sealing may be used as a standalone feature. To that extent, disclosed is a turboengine blading member, which comprises a platform and an airfoil. The airfoil comprises a pressure side, a suction side, a leading edge and a trailing edge. An upstream region of the airfoil extends from the leading edge in a direction towards the trailing edge, and a downstream region of the airfoil extends from the trailing edge in a direction towards the leading edge. The airfoil is connected to the platform in the upstream region. The airfoil is disconnected from the platform in the downstream region, such that the downstream region cantilevers from the upstream region, whereby a gap is formed between a cross sectional face of the airfoil in the downstream region and an opposed surface of the platform facing said cross sectional face. At least one fluid channel is provided in at least one of the platform and the airfoil and opens out into the gap. The fluid channel is at its outlet opening to the gap inclined such that a fluid flow discharged from the fluid channel is directed with a velocity component directed towards the pressure side of the airfoil. Thus, a fluid flow emanating from a fluid channel counteracts a leakage flow which is directed from the pressure side to the suction side and through the gap. Thus, the leakage flow may be significantly reduced. A fluid channel which is provided in the airfoil may be in fluid communication with a coolant duct provided inside the airfoil. A fluid channel which is provided in the platform may be provided in fluid communication with a cold fluid side of the platform. To that extent, a fluid flow emanating from the fluid channel may be provided as a coolant flow and serve to reduce thermal loading of the components which are located adjacent the gap. In another aspect, a method is disclosed for reducing a leakage flow through the gap which is provided between a cross sectional face of the trailing edge region of an airfoil and the opposed surface of the platform in a blading member. It is understood that in this respect the blading member comprises a platform and the airfoil, wherein the airfoil comprises a suction side, a pressure side, a leading edge and a trailing edge. The airfoil is connected to the platform in a leading edge or upstream region. A trailing edge or downstream region of the airfoil cantilevers from the leading edge region and is disconnected from the platform, such that a gap is formed between a cross sectional face of the airfoil in the downstream region and an opposed surface of the platform facing said cross-sectional face. The method comprises discharging a fluid into the gap with a velocity component directed towards the pressure side of the airfoil. The method may comprise supplying the fluid to the gap from at least one of a cold fluid side of the platform and a cooling duct provided inside the airfoil. The method may further comprise supplying the fluid to the gap from a coolant system of a turboengine.

As initially implied, the turboengine blading member may be a built blading member which is assembled from at least one platform member and at least one airfoil member.

As initially implied, the blading member may comprise a multitude of at least two airfoils. The blading member may comprise one platform, or it may comprise a platform provided at each spanwise end of an airfoil such as to provide a shrouded blading member.

Further disclosed is a turboengine comprising a turboengine blading member of the type disclosed above.

It is understood that the features and embodiments disclosed above may be combined with each other. It will further be appreciated that further embodiments are conceivable within the scope of the present disclosure and the claimed subject matter which are obvious and apparent to the skilled person.

### BRIEF DESCRIPTION OF THE DRAWINGS

The subject matter of the present disclosure is now to be explained in more detail by means of selected exemplary embodiments shown in the accompanying drawings. The figures show

FIG. 1 a plan view onto an exemplary blading member;

FIG. 2 a sectional side view of the blading member;

FIG. 3 a detail of FIG. 2 lining out in more detail the sealing arrangement;

FIG. 4 a sectional view depicting in more detail the mode of action of the sealing arrangement in a first tolerance condition of the platform and the downstream region of the airfoil;

FIG. 5 a sectional view depicting in more detail the mode of action of the sealing arrangement in a second tolerance condition of the platform and the downstream region of the airfoil;

FIG. 6 a sectional view depicting in more detail the mode of action of the sealing arrangement in a third tolerance condition of the platform and the downstream region of the airfoil; and

FIG. 7 a sectional view depicting in more detail the mode of action of the sealing arrangement in a fourth tolerance condition of the platform and the downstream region of the airfoil;

It is understood that the drawings are highly schematic, and details not required for instruction purposes may have been omitted for the ease of understanding and depiction. It is further understood that the drawings show only selected, illustrative embodiments, and embodiments not shown may still be well within the scope of the herein disclosed and/or claimed subject matter.

### EXEMPLARY MODES OF CARRYING OUT THE TEACHING OF THE PRESENT DISCLOSURE

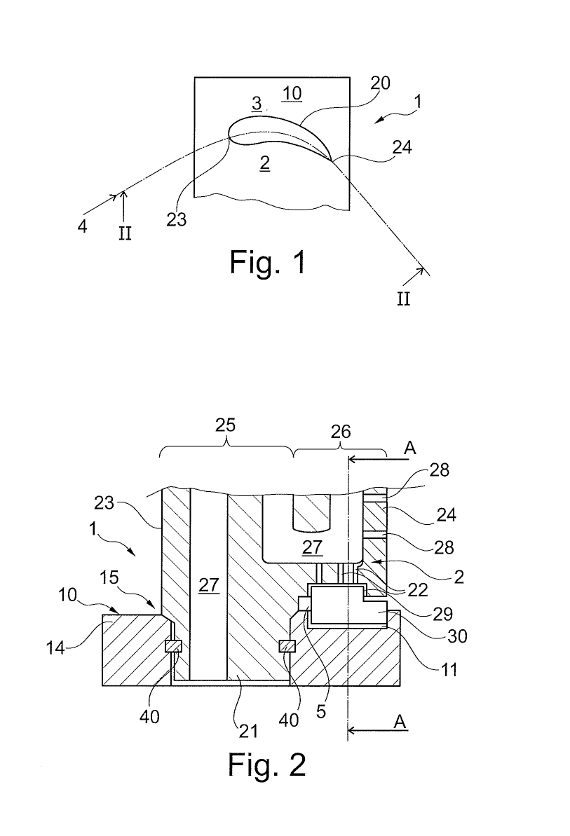

FIG. 1 depicts a plan view onto a part of a turboengine blading member 1. Blading member 1 comprises platform 10 and airfoil 20. Airfoil 20 is generally attached to platform 10 and extends from a hot fluid side of platform 10 in a manner well known to the skilled person. In the profile cross-section of airfoil 20, airfoil 20 exhibits a leading edge 23 and a trailing edge 24. Furthermore, it comprises a pressure side, denoted at 2, where the surface of the airfoil is concavely shaped, and a suction side 3, where the surface of the airfoil is convexly shaped. When a fluid flows onwards to leading edge 23 in a nominal inflow direction 4, and flows around the airfoil to trailing edge 24, a pressure differential is generated between pressure side 2 and suction side 3, resulting in a force on the airfoil directed from pressure side 2 to suction side 3. The pressure differential, however, also results in leakage flows through any gaps connecting pressure side 2 and suction side 3, for instance over the tip of an airfoil, or through any other gaps. Said leakages result in a performance deterioration, and moreover might expose components provided adjacent said gaps to an enhanced thermal loading.

It is moreover noted that a multitude of airfoils may be arranged on one platform, such that the blading member comprises a multitude of airfoils. Moreover, a platform may be attached to the tip of the airfoil such that the blading member comprises two platforms.

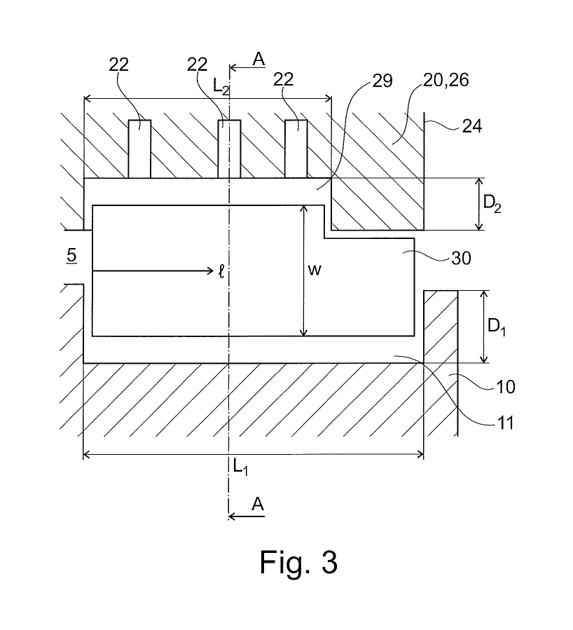

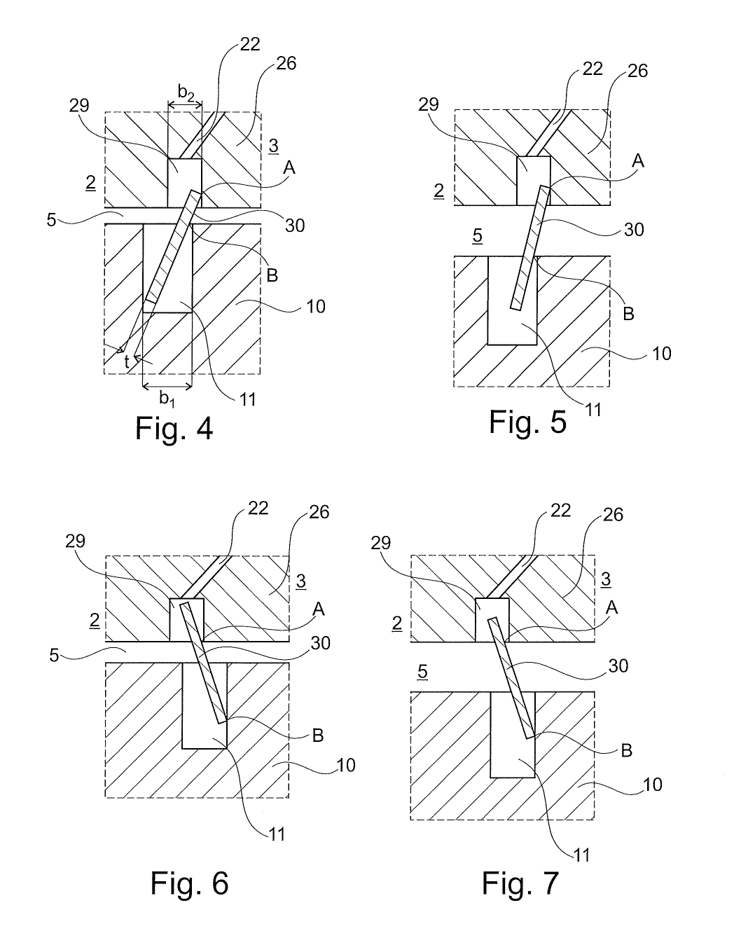

FIG. 2 shows a section along line II-II in FIG. 1. It becomes visible that blading member 1 is an assembled blading member comprising a platform member 14 which provides platform 10, and airfoil member 15. Airfoil member 15, in turn, comprises airfoil 20 and male fixation feature, or post, 21. Post 21 is inserted into a mating receiver opening provided in platform member 14. In a manner known from the art, each of post 21 and the receiver opening exhibit a groove, which, when the airfoil member is assembled, jointly form an interlocking cavity, in which an interlocking member 40 is formed. Interlocking member 40 interlocks platform member 14 and airfoil member 15. For several reasons, an upstream region 25 of airfoil 20 is attached to the platform through post 21, while a downstream region 26 of airfoil 20 cantilevers from upstream region 25 and is disconnected from platform 10. A gap 5 is formed between a cross-sectional face of downstream region 26 and an opposed surface of platform 10. Downstream region 26 of airfoil 20 thus may floatingly displace over platform 10. The skilled person will appreciate that usually the side of platform 10 from which airfoil 20 extends is subject to a working fluid of a turboengine at elevated temperatures during operation. The opposed side of platform 10 forms part of cooling fluid plenum. Cooling fluid from said plenum may enter coolant duct 27 provided in airfoil member 15 and thus serve to cool airfoil 20. The cooling fluid from duct 27 may for instance be discharged through trailing edge discharge orifices 28, which open out and trailing edge 24 and are in fluid connection with coolant duct 27. As becomes appreciated in connection with FIG. 1 and the specification relating thereto, a pressure gradient exists over gap 5 from pressure side 2 to suction side 3. As a consequence, hot working fluid flows through gap 5 and causes a performance deterioration, and moreover increases heat intake into airfoil 20 adjacent gap 5 in a region adjacent trailing edge 24, where material thickness is low. A sealing arrangement for gap 5 must take into account that the trailing edge region 26 floats over platform 10, and thus the relative position of trailing edge region 26 and platform 10 may vary. In particular, trailing edge 24 may experience relative displacement with respect to platform 10 due to different thermal expansion of platform 10 and airfoil 20. It will be appreciated that, while both components are cooled, the relation between heat intake from a hot working fluid flow and cooling might not be perfectly balanced at each location. In addition, under transient operation conditions it may be reasonably assumed that the temperature of airfoil 20 changes faster than the temperature of platform 10. Moreover, in an assembled blading member as shown, platform 10 and airfoil member 20 may be manufactured from different materials, to take into account different thermal and mechanical loading of the components, wherein the different materials may exhibit different thermal expansion gradients. The sealing arrangement as herein disclosed comprises airfoil pocket 29 provided in the airfoil and opening out onto a cross-sectional face of the downstream region 26 of airfoil 20 and being in communication with gap 5. In a surface of platform 10 opposite airfoil pocket 29, platform pocket 11 is provided, which opens out onto said surface and is in communication with gap 5. A sealing member 30 extends into and is received within airfoil pocket 29 as well as platform packet 11, and bridges gap 5. Sealing member 30 is loosely received within pockets 29 and 11. Thus, sealing member 30 inhibits leakage flow through 5, but, as will be outlined in more detail below, does not inhibit relative displacement between downstream region 26 of airfoil 20 and platform 10, at least in a certain range of relative displacement. Each of pockets 11 and 29 has an upstream end which is provided downstream from post 21, and extends in the streamwise direction, towards trailing edge 24, for a certain length. It will be appreciated, that the streamwise direction is directed from the leading edge 23 to trailing edge 24, and the terms upstream and downstream refer to said streamwise direction. The skilled person will appreciate that in the downstream direction towards trailing edge 24 the material strength of airfoil 20 decreases. Thus, it is not reasonably possible to provide an airfoil pocket immediately adjacent trailing edge 24. That is to say, airfoil pocket 29 can practically not extend right to trailing edge 24. However, in order to seal the gap at the trailing edge, sealing member 30 may be specifically shaped. Further explanations will become better appreciated by virtue of FIG. 3, which depicts the sealing arrangement of pockets 29 and 11 and sealing member 30 in more detail. Airfoil pocket 29 extends from an upstream end a distance L₂ into the downstream direction and towards trailing edge 24. Airfoil pocket 29 further exhibits a depth D₂. Platform pocket 11 extends from its upstream end a distance L₁ in the downstream direction. The depth of platform pocket 11 is D₁. Sealing member 30 is received in airfoil pocket 29 as well as in platform pocket 11. Sealing member 30 extends a length t downstream from an upstream end, and a width w bridging gap 5. In a region where it is received inside airfoil pocket 29, airfoil packet 29 exhibits a length which at most equals the length L₂ of airfoil pocket 29. However, in a region which is located outside airfoil pocket 29 sealing member 30 exhibits a higher length, and may extend right to trailing edge 24, and may in principle also extend further downstream than airfoil 20. Length L₁ of platform pocket 11 is larger than length L₂ of airfoil pocket 29. Further, fluid channels 22 are provided in airfoil 20 and opening out into airfoil pocket 29. As becomes appreciated by virtue of FIG. 3 in connection with FIG. 2, fluid channels 22 are in fluid communication with coolant duct 27. Thus, through fluid channels 22 a coolant may be discharged into airfoil pocket 29, and serves to cool sealing member 30 during operation. It will become more apparent by virtue of FIGS. 4 through 7 and the description thereof, that fluid discharged into gap 5, or into airfoil pocket 29, respectively, may also serve or support a sealing function.

As noted above, the downstream region of the airfoil may displace with respect to the platform, for instance due to different thermal expansion. Accordingly, airfoil pocket 29 displaces with respect to platform pocket 11. FIG. 4 shows a section along line A-A of FIGS. 2 and 3. FIG. 4 depicts a situation wherein the downstream region 26 of the airfoil is maximally displaced towards suction side 3 relatively to platform 10. A thickness t of sealing member 30 is smaller than a width b₁ of platform pocket 11 and smaller than a width b₂ of airfoil pocket 29. As was lined out in connection with FIG. 3, a with w of sealing member 30 is smaller than the combined depths of airfoil pocket 29 and platform pocket 11 plus a minimum width of gap 5. Thus, sealing member 30 is loosely received, with play, inside pockets 11 and 29. The sealing arrangement comprising an airfoil pocket 29 and platform pocket 11, and sealing member 30 received therein, is thus able to accommodate a certain displacement of the trailing edge or downstream region 26 of the airfoil relative to platform 10. Due to a pressure differential between pressure side 2 and suction side 3 of the airfoil, which becomes effective over gap 5, sealing member 30 experiences a rigid body motion towards suction side 3, and is caused to make line contact with the airfoil at A and with the platform at B. The contact pressure of sealing member 30 at lines A and B is proportional to the pressure differential between pressure side 2 and suction side 3. Thus, a self-sustaining sealing arrangement is achieved. FIG. 5 depicts a situation which is similar to that of FIG. 4, wherein the width of gap 5 is larger than in FIG. 4, and may be a maximum value upon which the design is based. As is appreciated, the play within pockets 11 and 29 allows sealing member 30 to adapt to the different geometry and again make line contact with the airfoil, or the downstream region 26 thereof, respectively, and platform 10, at contact lines A and B.

FIGS. 6 and 7 illustrate the situation when the downstream region 26 of the airfoil is maximally displaced relatively to platform 10 towards the pressure side 2. FIG. 6 shows the situation with a narrow gap 5 between the downstream region 26 of the airfoil and platform 10, whereas FIG. 7 illustrates a situation where the width of gap 5 is a maximum value. Again, it becomes readily apparent how sealing member 30 is able to adapt its position inside pockets 29 and 11 to the actual relative positions of the downstream region 26 of the airfoil and platform 10.

It is further seen in FIGS. 4 through 7 that fluid channel 22 is slanted such that a fluid discharged from fluid channel 22 is discharged with a velocity component towards pressure side 2. In that a coolant flow emanating from fluid duct 22 is directed against the direction of a potential leakage flow, a further aerodynamic sealing effect is achieved.

It is apparent that the turboengine blading member disclosed herein is equipped with a sealing arrangement which acts in a self-supporting manner to reduce or even block a leakage flow through a gap between a cantilevering downstream region of an airfoil and a platform.

While the subject matter of the disclosure has been explained by means of exemplary embodiments, it is understood that these are in no way intended to limit the scope of the claimed invention. It will be appreciated that the claims cover embodiments not explicitly shown or disclosed herein, and embodiments deviating from those disclosed in the exemplary modes of carrying out the teaching of the present disclosure will still be covered by the claims.

### LIST OF REFERENCE NUMERALS

1 turboengine blading member
2 pressure side
3 suction side
4 nominal inflow direction
5 gap
10 platform
11 platform pocket
14 platform member
15 airfoil member
20 airfoil
21 male fixation feature, post
23 leading edge
24 trailing edge
25 upstream or leading edge region of airfoil
26 downstream or trailing edge region of airfoil
27 coolant duct
28 coolant discharge orifice, trailing edge discharge orifice
29 airfoil pocket
30 sealing member
40 interlocking member
b₁ width of platform pocket
b₂ width of airfoil pocket
l length of sealing member
t thickness of sealing member
w width of sealing member
A contact line
B contact line
D₁ depth of platform pocket
D₂ depth of airfoil pocket
L₁ length of platform pocket
L₂ length of airfoil pocket

1. A turboengine blading member, comprising:
a platform;
an airfoil, the airfoil having a pressure side, a suction side, a leading edge and a trailing edge, an upstream region of the airfoil extending from the leading edge in a direction towards the trailing edge and a downstream region of the airfoil extending from the trailing edge in a direction towards the leading edge,
the airfoil being connected to the platform in the upstream region,
the airfoil being disconnected from the platform in the downstream region, such that the downstream region cantilevers from the upstream region, whereby a gap is formed between a cross sectional face of the airfoil in the downstream region and an opposed surface of the platform facing said cross sectional face;
an airfoil pocket in the downstream section of the airfoil and opening out onto the cross sectional face of the airfoil;
a platform pocket in the platform and opening out onto a surface of the platform opposite the airfoil pocket, the airfoil pocket and the platform pocket being arranged with mutually facing openings; and
a sealing member provided inside the airfoil and platform pockets and extending into the airfoil pocket as well as into the platform pocket and thereby bridging the gap, the sealing member exhibiting a length (l) which extends in a direction from the upstream region of the airfoil towards the trailing edge and a width (w) which extends in a direction from one of the airfoil pocket and the platform pocket to the other pocket of the airfoil pocket and the platform.

2. The turboengine blading member according to claim 1, wherein the sealing member is loosely received within the airfoil pocket and the platform pocket.

3. The turboengine blading member according to claim 1, wherein each of the airfoil pocket and the platform pocket exhibits a length (L1, L2) extending in a direction from the upstream region of the airfoil towards the trailing edge and a width (b1, b2) extending in a direction from the pressure side towards the suction side of the airfoil, wherein the length of the pocket is larger than the width of the pocket.

4. The turboengine blading member according to claim 1, wherein each of the airfoil pocket and the platform pocket exhibits a width (b1, b2) extending in a direction from the pressure side of the airfoil to the suction side of the airfoil, and a depth (D1, D2), wherein the depth of each of the airfoil pocket and platform pocket is larger than the width of the respective pocket.

5. The turboengine blading member according to claim 1, wherein each of the airfoil pocket and the platform pocket exhibits a length (L1, L2) extending in a direction from the upstream region of the airfoil towards the trailing edge, and a depth (D1, D2) wherein the depth of each of the airfoil pocket and platform pocket is smaller than the length of each respective pocket.

6. The turboengine blading member according to claim 1, wherein the airfoil pocket extends from an upstream end of the airfoil pocket to a downstream end of the airfoil pocket, the downstream end of the airfoil pocket being located upstream the trailing edge, wherein the sealing member comprises:
a first section which is received inside the airfoil pocket and a second section which is located outside the airfoil pocket, wherein the second section extends further downstream than the downstream end of the airfoil pocket.

7. The turboengine blading member according to claim 6, wherein the length (l) of the first section of the sealing member equals the length (L2) of the airfoil pocket.

8. The turboengine blading member according to claim 3, wherein a section of the sealing member which is received inside the platform pocket exhibits a length (l) which equals the length (L1) of the platform pocket.

9. The turboengine blading member according to claim 3, wherein the sealing member exhibits a thickness (t), wherein the thickness extends in a direction between the pressure side and the suction side, wherein the thickness of the sealing member, in a section of the sealing member which is received inside the airfoil pocket, is smaller than the width (b2) of the airfoil pocket.

10. The turboengine blading member according to claim 1, wherein the sealing member exhibits a thickness (t), wherein the thickness extends in a direction between the pressure side and the suction side, wherein the thickness of the sealing member in a section of the sealing member which is received inside the platform pocket is smaller than the width of the platform pocket.

11. The turboengine blading member according to claim 1, comprising:
a fluid channel within in the airfoil, in fluid communication with an interior of the airfoil and with the gap such as to enable a fluid flow from the interior of the airfoil to the gap.

12. The turboengine blading member according to claim 10, wherein the platform comprises:
a hot fluid side on which the airfoil is arranged;
an opposed cold fluid side; and
a fluid channel which extends from the cold fluid side to the gap such as to provide a fluid communication between the cold fluid side and the gap.

13. The turboengine blading member according to claim 11, wherein the fluid channel at its outlet opening which opens out to the gap is inclined such that a fluid flow when discharged from the fluid channel will be directed with a velocity component directed towards the pressure side of the airfoil.

14. The turboengine blading member according to claim 1, configured as a built blading member which is assembled from at least one platform member and at least one airfoil member.

15. A turboengine, comprising:
a turboengine blading member according to claim 1.
